(19) United States
(12) Patent Application Publication
(10) Pub. No.: US 2009/0079288 A1
(43) Pub. Date: Mar. 26, 2009

(54) MOTOR WINDING BOBBIN AND TERMINAL STRUCTURE THEREOF

(75) Inventors: Wen-Shi Huang, Taoyuan Hsien (TW); Chin-Chu Hsu, Taoyuan Hsien (TW); Chun-Hua Yang, Taoyuan Hsien (TW); Chia-Ying Hsu, Taoyuan Hsien (TW)

Correspondence Address: Muncy, Geissler, Olds & Lowe, PLLC, P.O. BOX 1364, FAIRFAX, VA, 22038-1364, US

(73) Assignee: DELTA ELECTRONICS, INC.

(21) Appl. No.: 12/109,981

(22) Filed: Apr. 25, 2008

(30) Foreign Application Priority Data
Sep. 21, 2007 (TW) 096135409

(51) Int. Cl. H02K 3/46

(52) U.S. Cl. 310/194

(57) ABSTRACT

A motor winding bobbin and terminal structure there are disclosed. The terminal structure includes a fixing portion and at least one positioning portion. The fixing portion is disposed at one end of the terminal structure and has at least one fixing pattern. The fixing portion is connected with a connecting end of the motor winding structure. The positioning portion is disposed adjacent to the fixing portion and urged against the motor winding structure for positioning the fixing portion while it is connected with the connecting end.

### CROSS REFERENCE TO RELATED APPLICATIONS

This Non-provisional application claims priority under 35 U.S.C. §119(a) on Patent Application No(s). 096135409, filed in Taiwan, Republic of China on Sep. 21, 2007, the entire contents of which are hereby incorporated by reference.

### BACKGROUND OF THE INVENTION

1. Field of Invention

The present invention relates to a motor winding bobbin and a terminal structure thereof and in particular to a terminal structure capable of firmly connecting with the motor winding bobbin.

2. Related Art

The connecting methods between components of an electronic device and terminals are optional depending on the materials and applications. For example, the connection of metals is usually done by soldering. The connection of plastic components is usually done by melting or via an adhesive. In addition, the connection between the plastic component and metal terminal is also common in motors and its output terminals.

As shown in FIG. 1A and FIG. 1B, a conventional terminal structure 1 is inserted to a connecting end 21 of a motor winding structure 2. The connecting end 21 is made by plastic, and the terminal structure 1 is made by metal. The terminal structure 1 has an end 11 with a round, smooth surface. The connection between the terminal structure 1 and the winding structure 2 is done by inserting the end 11 into the connecting end 21 so as to fix the end 11 in the connecting end 21.

However, when the terminal structure 1 is inserted into the connecting end 21, the precision of inserting position is completely controlled by tools or machines. Each of the terminal structure 1 and the winding structure 2 has its material tolerance. Therefore, inserting position of the terminal structure 1 into the winding structure 2 cannot be accurately controlled. This may result in damages to the winding structure 1, thereby making the terminal structure loose, increasing the production cost and reducing the product reliability. For example, when the insertion of the terminal structure 1 into the winding structure 2 is not deep enough, the terminal structure 1 is likely to depart from the winding structure because of insufficient support. On the other hand, if the insertion of the terminal structure 1 into the winding structure 2 is too deep, the winding structure 2 may be pierced through by the terminal structure 1 and thus broken, as shown in FIG. 1A.

Moreover, the winding structure 2 is electrically connected with an external system via the terminal structure 1. Therefore, the terminal structure 1 is pushed or pulled by an external force when the winding structure 2 is combined with or departed from the external system. Since the connection between the terminal structure 1 and the winding structure 2 is merely a tight contact, the connecting force therebetween is fairly weak. Once the above-mentioned external force is imposed on the terminal structure 1, the terminal structure 1 is pushed inward to damage the winding structure 2 or pulled away from the winding structure 2.

To avoid the above-mentioned problem, one conventional method is to adhere or weld the terminal structure 1 and the winding structure 2 together to increase the connecting force therebetween. However, this method largely increases the production processes involved therein. It also requires additional connecting materials, tools and machines. Thus, both the production time and cost increase.

### SUMMARY OF THE INVENTION

In view of the foregoing, the present invention is to provide a motor winding bobbin and a terminal structure thereof capable of increasing the connecting strength there between, thereby preventing loose connections or departure, ensuring the product reliability, simplifying the man manufacturing process, and decreasing the cost.

In addition, the present invention is also to provide a terminal structure that efficiently buffers improper actions imposed on the motor winding bobbin to ensure the product reliability.

To achieve the above, the present invention discloses motor winding bobbin including a terminal structure. The terminal structure includes a fixing portion and at least one positioning portion. The fixing portion is disposed on one end of the terminal structure and has at least one fixing pattern for connecting with a connecting end of the motor winding bobbin. The positioning portion is disposed adjacent to the fixing portion to urge against the electronic device, thereby positioning the fixing portion to a connecting position of the connecting end.

In the terminal structure of the present invention, the fixing pattern has at least one fixing pattern, such as a saw-like, wavy, stripe, curved, regular, or irregular pattern. The fixing pattern is formed around an axial direction of the fixing portion, or the fixing pattern is formed on only one side of the fixing portion.

In addition, the present invention further discloses a terminal structure including a fixing portion and at least one positioning portion. The fixing portion is disposed on one end of the terminal structure for connecting with a connecting end of an electronic device, such as a motor winding bobbin. The positioning portion is disposed adjacent to the fixing portion to urge against the electronic device, thereby positioning the fixing portion to the connecting position of the connecting end. The positioning portion is a bending structure or a protrusion.

As mentioned above, the terminal structure of the present invention has a fixing pattern that can increase the connecting force between the terminal structure and the electronic device so that the terminal structure cannot be easily pulled away from the electronic device. Since the terminal structure of the present invention has a positioning portion, the connecting depth of the terminal structure in the connecting end of the electronic device can be accurately positioned. The buffering portion of the terminal structure can greatly reduce the force applying on the contact portion between the terminal structure and the connecting end. The above-mentioned features of the present invention can prevent damages to the electronic device, increase the stability of the system, simplify the manufacturing process, and decrease the production cost.

### BRIEF DESCRIPTION OF THE DRAWINGS

The present invention will become more fully understood from the detailed description and accompanying drawings, which are given for illustration only, and thus are not limitative of the present invention, and wherein:

FIG. 1A is a cross-sectional view of a conventional winding structure and its terminal structure;

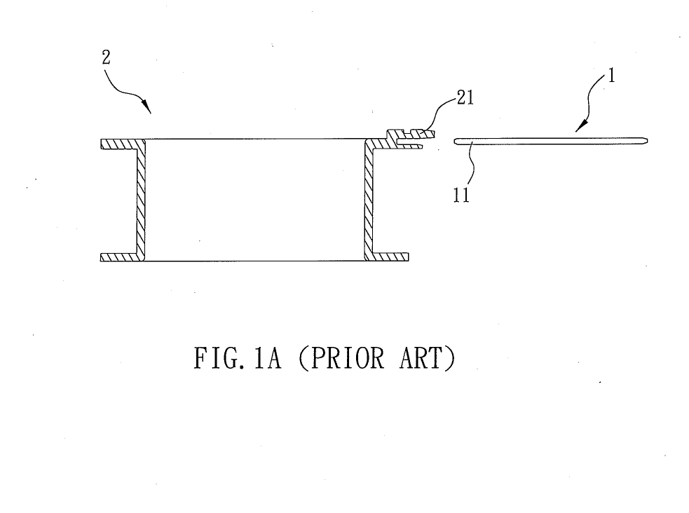

FIG. 1B is a cross-sectional view showing the terminal structure in FIG. 1A is inserted into the conventional winding structure;

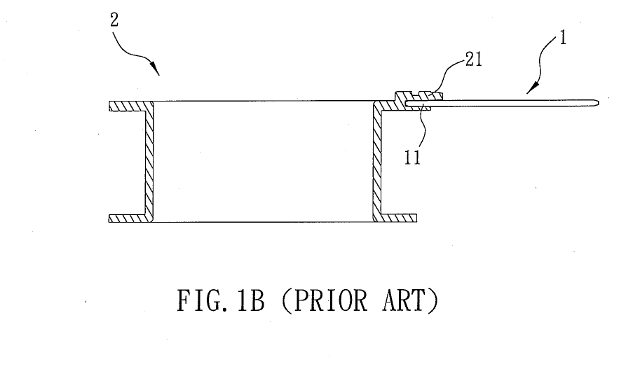

FIG. 2A is a cross-sectional view of a motor winding bobbin and a terminal structure thereof according to a preferred embodiment of the present invention; and

FIG. 2B is a cross-sectional view showing the terminal structure in FIG. 2A is inserted into the winding structure according to a preferred embodiment of the present invention.

### DETAILED DESCRIPTION OF THE INVENTION

The present invention will be apparent from the following detailed description, which proceeds with reference to the accompanying drawings, wherein the same references relate to the same elements.

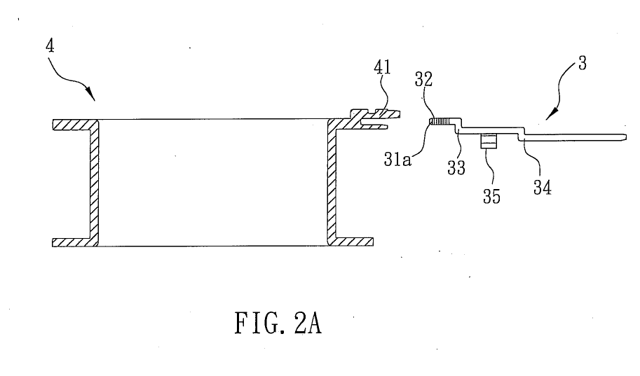

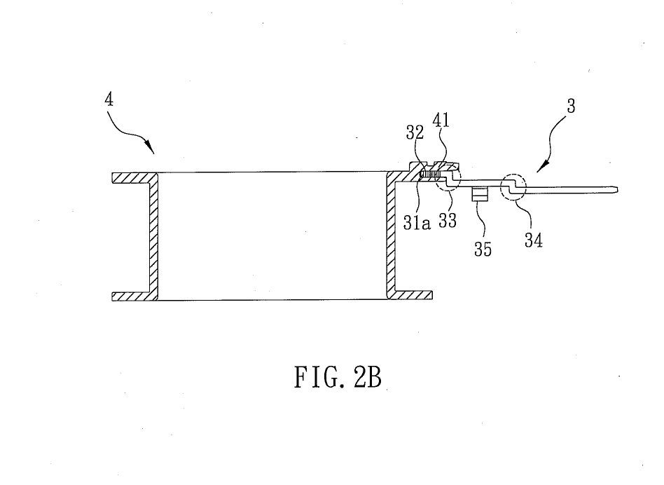

As shown in FIG. 2A and FIG. 2B, a terminal structure 3 according to a preferred embodiment of the present invention is inserted into a connecting end 41 of an electronic device 4. The terminal structure 3 has a fixing portion 32 and at least one positioning portion 33. The terminal structure 3 can be integrally formed. More explicitly, the fixing portion 32 and the positioning portion 33 are integrally formed as a single unit. In this embodiment, the electronic device 4 is a motor winding structure. The material of the terminal structure 3 is gold, silver, copper, aluminum or any other conductive material.

The fixing portion 32 is used to connect with the connecting end 41 of the electronic device 4. The fixing portion 32 is disposed on one end of the terminal structure 3 and has at least one fixing pattern 31a. The fixing pattern 31a can increase the connecting strength between the fixing portion 32 and the connecting end 41. In addition, the shape of the fixing portion 32 can be flat, conic, round or polygonal.

The fixing pattern 31a can be a saw-like, wavy, stripe, curved, regular or irregular pattern. The fixing pattern 31a is formed around the axial direction of the fixing portion 32 or at least one side of the fixing portion 31a.

The positioning portion 33 is disposed adjacent to the fixing portion 32 to urge against the electronic device 4, thereby fixing the connecting position of the fixing portion 32 in the connecting end. The positioning portion 33 can be a bending structure or a protrusion. The bending direction or protruding direction of the positioning portion 33 is different from the extending direction of the fixing portion 32. There can be one or several bendings on the positioning portion 33. When there are many bendings, only at least one of them (e.g., the one closest to the fixing potion 32) needs to be in a direction different from the extending direction of the fixing portion 32.

The terminal structure 3 further has at least one buffering portion 34 disposed at any position thereon other than the positioning portion 33 and the fixing portion 32 for absorbing the force from the terminal structure 3. The buffering portion 34 can be a bending structure with one or several bendings.

The terminal structure 3 further has at least one connecting point 35 disposed at any position thereon other than the positioning portion 33 and the fixing portion 32 for electrically connecting with a motor winding. For the sake of safety, the connecting point 35 cannot have a contact with the winding structure 3.

When an external pulling force is imposed on the terminal structure 3, the fixing portion 32 is not easily pulled away from the connecting end 41 because of the stronger connecting force therebetween due to the fixing pattern 31a. Moreover, as the terminal structure 3 is under this external pulling force, the buffering portion 34 absorbs most of the pulling force, so as to greatly reduce the strength of the external pulling force on the fixing portion 32.

When a pushing force is imposed on the terminal structure 3, the positioning portion 33 prevents the terminal structure 3 from further inserting into the connecting end 41. Therefore, it can effectively avoid damages of the terminal structure 3 on the connecting end 41. It also ensures the connecting position of the terminal structure 3 in the electronic device 4. As the terminal structure 3 receives the inward pushing force, the positioning portion 33 and/or buffering portion 34 absorbs most of the force, so as to greatly reduce the strength of the pushing force on the terminal structure 3.

In summary, the terminal structure of the present invention has a fixing pattern that can increase the connecting force between the terminal structure and the electronic device so that the terminal structure cannot be easily pulled away from the electronic device. Since the terminal structure of the present invention has a positioning portion, the connecting depth of the terminal structure in the connecting end of the electronic device can be accurately positioned. The buffering portion of the terminal structure can greatly reduce the force applying on the contact portion between the terminal structure and the connecting end. The above-mentioned features of the present invention can prevent damages to the electronic device, increase the stability of the system, simplify the manufacturing process, and decrease the production cost.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A terminal structure, comprising:
a fixing portion disposed on one end of the terminal structure for connecting with a connecting end of an electronic device; and
at least one positioning portion disposed adjacent to the fixing portion to urge against the electronic device, thereby positioning the fixing portion to a connecting position of the connecting end.

2. The terminal structure of claim 1, wherein a shape of the fixing portion is flat, conic, round or polygonal.

3. The terminal structure of claim 1, wherein the fixing portion and the positioning portion are integrally formed as a single unit.

4. The terminal structure of claim 1, wherein the fixing portion has at least one fixing pattern, such as a saw-like, wavy, stripe, curved, regular, or irregular pattern.

5. The terminal structure of claim 4, wherein the fixing pattern is formed around an axial direction of the fixing portion, or the fixing pattern is formed on only one side of the fixing portion.

6. The terminal structure of claim 1, wherein the positioning portion is a bending structure or a protrusion, and a bending or protruding direction of the positioning portion is different from an extending direction of the fixing portion.

7. The terminal structure of claim 6, wherein the positioning portion comprises one or more than one bending, and when the positioning portion comprises a plurality of bendings, at least one of the bendings has a bending direction different from the extending direction of the fixing portion.

8. The terminal structure of claim 1, further comprising at least one buffering portion disposed at any position other than the positioning portion and the fixing portion.

9. The terminal structure of claim 8, wherein the buffering portion is a bending structure, and the buffering portion comprises one or a plurality of bendings.

10. The terminal structure of claim 1, wherein the electronic device is a motor winding structure.

11. The terminal structure of claim 10, further comprising a connecting point, disposed at any position other than the positioning portion and the fixing portion, for electrically connecting with a motor winding.

12. The terminal structure of claim 1, wherein a material of the terminal structure comprises gold, silver, cooper, aluminum, metal or any other conductive materials.

13. A motor winding bobbin, comprising:
a terminal structure, comprising a fixing portion and at least one positioning portion;
wherein the fixing portion is disposed on one end of the terminal structure for connecting with a connecting end of the motor winding bobbin;
wherein the at least one positioning portion is disposed adjacent to the fixing portion to urge against the electronic device, thereby positioning the fixing portion to the connecting position of the connecting end.

14. The motor winding bobbin of claim 13, wherein a shape of the fixing portion is flat, conic, round or polygonal.

15. The motor winding bobbin of claim 13, wherein the fixing portion and the positioning portion are integrally formed as a single unit.

16. The motor winding bobbin of claim 13, wherein the fixing portion has at least one fixing pattern, such as a saw-like, wavy, stripe, curved, regular, or irregular pattern.

17. The motor winding bobbin of claim 16, wherein the fixing pattern is formed around an axial direction of the fixing portion, or the fixing pattern is formed on only one side of the fixing portion.

18. The motor winding bobbin of claim 13, wherein the positioning portion is a bending structure or a protrusion, and the bending or protruding direction of the positioning portion is different from an extending direction of the fixing portion.

19. The motor winding bobbin of claim 18, wherein the positioning portion comprises one or more than one bending, and when the positioning portion comprises a plurality of bendings, at least one of the bendings has a bending direction different from the extending direction of the fixing portion.

20. The motor winding bobbin of claim 13, further comprising a connecting point, disposed at any position other than the positioning portion and the fixing portion, for electrically connecting with a motor winding.
